(19) United States
(12) Patent Application Publication
(10) Pub. No.: US 2008/0238316 A1
(43) Pub. Date: Oct. 2, 2008

(54) PLASMA DISPALY PANEL AND MANUFACTURING METHOD OF THE SAME

(76) Inventors: Mitsuo Hayashibara, Hitachinaka (JP); Yuichi Sawai, Miyazaki (JP); Hiroki Yamamoto, Hitachi (JP); Motoyuki Miyata, Hitachinaka (JP); Fusao Hojo, Tokai (JP); Takashi Naito, Funabashi (JP); Keiichi Kanazawa, Ome (JP); Tatsuya Miyake, Tokorozawa (JP); Hideto Momose, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,038

(22) Filed: Jan. 24, 2008

(30) Foreign Application Priority Data
Mar. 30, 2007 (JP) 2007-090557

(51) Int. Cl. H01J 9/26; H01J 17/49

(52) U.S. Cl. 313/582; 445/25

(57) ABSTRACT

The purpose of the present invention is to provide a plasma display panel containing black colored parts which have high resistant against degradation in blackness or peeling by high-temperature oxidation. The present invention provides a plasma display panel comprises: a front substrate and a rear substrate, edge portions of which are adhered to each other, the both substrates being provided opposite to each other; an electrode provided on the front substrate, a dielectric layer provided on the electrode; a protective layer provided on the dielectric layer; a black compound layer having an opening on the protective layer; an electrode and a dielectric layer provided on the rear substrate; a barrier rib holding a gap between the front substrate and the rear substrate; and a phosphor filled in a space formed by the barrier rib, wherein the black compound layer is formed on the front substrate side seen from the barrier rib, wherein the black compound layer comprises a mixture of a ceramics filler and a glass, and wherein the glass comprises a phosphate glass containing a transition metal element.

### FIELD OF THE INVENTION

The present invention relates to a plasma display panel and a manufacturing method of the same.

### BACKGROUND OF THE INVENTION

Conventionally, a black striped layer called a black matrix (hereinafter, abbreviated as a BM) has been provided as a means for improving the contrast of a plasma display. As the material of the BM, the oxides of Ru, Mn, Ni, Cr, or the like described in Patent Document 1 are used. Moreover, as described in Patent Document 2, for the purpose of prevention of degradation of blackness of the BM material, a technique for covering the surface of a low-level titanium oxide (BM material) with a compound, such as silica, alumina, or titania, is known.

(Patent Document 1) JP-A-2002-16836

(Patent Document 2) JP-A-2002-363441

### BRIEF SUMMARY OF THE INVENTION

Usually, in a plasma display panel (hereinafter, abbreviated as a PDP), a transparent electrode is formed on a front substrate, and then a bus electrode is formed, and on top of this a BM, a dielectric layer, and a protective layer are formed. The dielectric layer is formed by printing and calcining a glass paste. Namely, after printing and calcining a BM, the BM is subjected to a heating process again. In this case, for the conventional black inorganic pigments as shown in Patent Document 1, many of them changes color tone due to a reduction reaction or the like when heated to high temperature in the atmosphere, and some of them react with a peripheral material to peel off. Moreover, in Patent Document 2, this problem is avoided by coating and stabilizing the surface of an oxygen deficiency type titanic oxide, however, this measure is disadvantageous in terms of cost because the number of process steps is increased.

It is an object of the present invention to provide a PDP having a BM that exhibits a stable black color even in a high temperature oxidizing atmosphere, and a method of producing the same without increasing the number of process steps.

The present invention provides a plasma display panel comprising:
a front substrate and a rear substrate, edge portions of which are adhered to each other, the both substrates being provided opposite to each other;
an electrode provided on the front substrate;
a dielectric layer provided on the electrode;
a protective layer provided on the dielectric layer;
a black compound layer having an opening on the protective layer;
an electrode provided on the rear substrate;
a dielectric layer provided on top of the electrode provided on the rear substrate;
a barrier rib holding a gap between the front substrate and the rear substrate; and
a phosphor filled in a space formed by the barrier rib,
wherein the plasma display panel comprises the black compound layer on a front substrate side seen from the barrier rib,
wherein the black compound layer comprises a mixture of a ceramics filler and a glass, and wherein the glass comprises a phosphate glass containing a transition metal element.

The transition metal element is preferably at least one kind selected from the group consisting of vanadium, tungsten, molybdenum, niobium, and iron.

The glass is preferably a vanadium phosphate glass having a composition ratio of 30 to 60 wt % of V₂O₅, 15 to 40 wt % of P₂O₅, 2 to 25 wt % of BaO, 5 to 30 wt % of Sb₂O₃, and 0 to 15 wt % of WO₃, in terms of oxides of each element.

The vanadium phosphate based glass with the above-described composition ratio has a glass softening temperature from 450° C. to 550° C. The temperature at which the dielectric layer of the front substrate is calcined is typically in the range from 500° C. to 600° C. In order to adhere the glass used in a BM at the temperature range from 500° C. to 600° C., the vanadium phosphate glass preferably has the above-described composition ratio.

Here, since BaO is a network modifier oxide and is effective in stabilizing the vanadium phosphate glass, 2 to 25 wt % of BaO is preferably contained. Since Sb₂O₃ is effective in improving the water resistance of the glass, 5 to 30 wt % of Sb₂O₃ is preferably contained.

Moreover, when the calcination temperature of the dielectric layer varies depending on the quality of the material of the dielectric layer, the composition may be reviewed so that the softening temperature of the vanadium phosphate glass becomes lower than the calcination temperature of the dielectric layer by 50° C. to 100° C. Thus, the BM glass of the present invention is not limited to the above-described composition ratio.

Furthermore, the glass of the present invention may contain 0 to 15 wt % of WO₃. WO₃ is a glass forming oxide as well as V₂O₅ is, and is not an essential component but is effective in increasing the softening temperature of the glass, so WO3 is used as appropriate.

Similarly, the glass may contain an alkali metal composed of Na or K. The content of Na or K is equal to or less than 10 wt % in terms of R₂O (Na₂O, K₂O) oxides when the alkali metal is denoted by R. The electric resistivity can be increased by adding R₂O although R₂O is not an essential component. Moreover, the glass may contain 0 to 5 wt % of TeO₂. TeO₂ is an intermediate oxide and is used as appropriate since TeO₂ is effective in reducing the softening temperature of the glass although TeO₂ is not an essential component, either.

In producing a BM using such a glass, a too high fluidity of the BM at a temperature at which the dielectric layer is printed onto the front substrate is not preferable. Then, by mixing 30 to 90 vol % of the ceramic filler with respect to 10 to 70 vol % of the glass, the fluidity during calcination of the dielectric layer can be adjusted. This takes advantage of the tendency of the fluidity of the BM to decrease when a mixed amount of the ceramic filler with respect to that of the glass is increased.

If the particle diameter of a ceramic filler is too large, the fluidity of the mixture will increase, i.e., the shape maintainability will decrease. If the particle diameter of a ceramic filler is too small, the likelihood of glass crystallization will increase and additionally the ceramic filler is unlikely to disperse in the paste. If the glass is crystallized, a vibrant black will be faded. Accordingly, the minimum average particle diameter of a ceramic filler is set to 1 μm. Moreover, since the line width of the BM is typically 50 μm, the average particle diameter of a ceramic filler is set to 10 μm at a maximum.

The ceramic filler can be an oxide or composite oxide of one or more kinds selected from the group consisting of Fe, Mn, Co, Cu, Cr, Ru, Ti, Ni, Mo and Nd.

A role of the ceramic filler is to match the thermal expansion coefficient of a glass of the present invention with that of the front glass substrate. Any ceramics whose thermal expansion coefficient is lower than that of the glass of the present invention can be employed, but as an inexpensive ceramic filler generally used, it is preferable that any one kind or a mixture of two or more kinds selected from the group consisting of SiO₂, ZrO₂, Al₂O₃, ZrSiO₄, cordierite, mullite, and eucryptite is used.

As a feature of a panel structure concerning the present invention, in a plasma display described above, the black compound layer of a high aspect structure is formed between the dielectric layer and the front substrate side. Moreover, the black compound layer may be formed on the front substrate side of a line-shaped barrier rib and also be formed in the direction intersecting with the barrier rib on the front substrate.

Moreover, in a plasma display having a grid-shaped barrier rib, a step can be provided in a part of the barrier rib or the black compound layer is formed in a chain shape.

Furthermore, in either structure, in order to prevent the charges stored in the dielectric substance from leaking through a black compound, the black compound preferably has a resistivity equal to or higher than 10⁷ Ωcm.

In a method for manufacturing the above plasma display panel, a barrier rib material is printed on the protective layer on the front substrate, and a black compound comprising a mixture of a ceramics filler and a glass is printed on the barrier rib material printed, and after subjecting to a curing treatment, a part thereof is removed and then the rear substrate side is integrated with the front substrate side by melting the black compound. Alternatively, a black compound comprising a mixture of a ceramics filler and a glass is printed on the front substrate and is heated to form a layer of the black compound, and then the front substrate is jointed to the rear substrate to form a panel. In this way, a panel can be produced using a simple method without increasing the number of the conventional process steps.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of a PDP using a black compound of the present invention.

FIG. 2 is a view showing the results of a study of composition range of a barrier rib glass.

FIG. 3 is a configuration diagram of a barrier rib, an electrode, and the like concerning the present invention.

FIG. 4 is a configuration diagram of a PDP using a black compound of the present invention.

FIG. 5 is a configuration diagram of a PDP using a black compound of the present invention.

FIG. 6 is a configuration diagram of a PDP using a black compound of the present invention.

FIG. 7 is a configuration diagram of a black compound, a barrier rib, an electrode, and the like concerning the present invention.

FIG. 8 is a view showing a method of producing a barrier rib and a black compound layer concerning the present invention.

FIG. 9 is a configuration diagram of a black compound and a barrier rib concerning the present invention.

FIG. 10 is a configuration diagram of a black compound and a barrier rib concerning the present invention.

### DESCRIPTION OF REFERENCE NUMERALS

1 . . . front substrate, 2 . . . rear substrate, 3 . . . display electrode, 4 . . . data electrode, 5 . . . phosphor, 6 . . . phosphor, 7 . . . phosphor, 8 . . . barrier rib, 9a, 9b . . . dielectric layer, 10 . . . protective layer, 11 . . . ultraviolet ray, 12 . . . adhering portion, 13 . . . black compound layer, 14 . . . transparent electrode, 15 . . . bus electrode, 20 . . . barrier rib material, 21 . . . black compound, 22 . . . grid-shaped barrier rib.

### DETAILED DESCRIPTION OF THE INVENTION

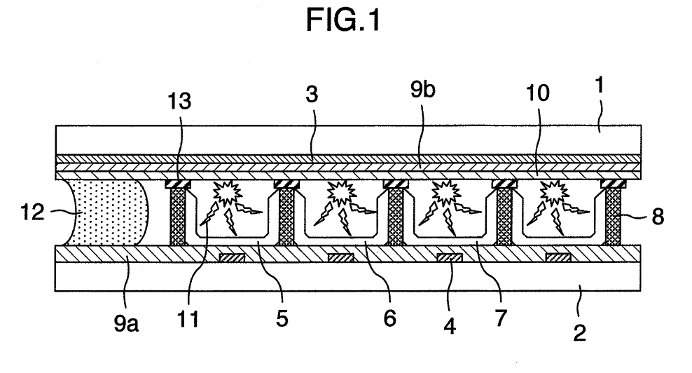

A plasma display device is a display device that generates an electric discharge within a microscopic space filled with a rare gas, such as neon or xenon, and thereby causes a filled phosphor to emit light. FIG. 1 is a view schematically showing a PDP.

In the PDP, a front substrate 1 and a rear substrate 2 are disposed opposite to each other with a gap of 100 to 200 μm therebetween and the gap between the respective substrates is maintained with a barrier rib 8. The edge portions of the substrates are sealed with an adhesive material that is mainly composed of glass, and the interior thereof is filled with a rare gas. A microscopic space separated by each substrate and the barrier rib is referred to as a cell. This cell is filled with phosphors 5, 6, 7 of three colors of R (Red), G (Green), and B (Blue), (hereinafter, referred to as RGB), respectively, and cells of three colors constitute a pixel to emit light of each color.

Regularly arrayed electrodes are provided in each substrate. In response to a display signal, a voltage of 100 to 200 V is selectively applied to between an electrode on the front substrate and an electrode on the rear substrate, the electrodes serving as a pair, to cause an electric discharge between the electrodes. This discharge generates an ultraviolet ray 11, which causes a phosphor to emit light, thereby displaying image information.

On the rear substrate side of the PDP, a data electrode 4 (or address electrode) is formed on the substrate. The data electrode comprises Cr/Cu/Cr wiring, silver wiring, or the like. This electrode is formed using a printing method or a sputtering method.

An address discharge is carried out between an address electrode and a display electrode of a cell desired to be turned on, whereby wall charges are stored in the cell. Next, an application of a fixed voltage to a pair of display electrodes causes a display discharge only in a cell, where the wall charges are stored due to the address discharge, thereby generating an ultraviolet ray. Through such a mechanism, displaying on a plasma display is carried out.

A dielectric layer 9 is formed on the data electrode. The dielectric layer 9a is provided for controlling the current of an address electrode and for protecting the data electrode from dielectric breakdown. On top of the dielectric layer 9a, a barrier rib 8 having an opening of a stripe shape, a grid shape, or the like is formed. The barrier rib 8 has a shape such as a straight line (stripe shaped, partition shaped), or a grid shape, and is formed by applying a paste-like material serving as a barrier rib by a printing method, and then scraping this by a sandblasting method. Within a cell separated by a barrier rib, the phosphor 5, 6, or 7 of each color is applied to the wall surface.

On the other hand, on the front substrate, a display electrode 3 is formed. The display electrode 3 comprises a transparent electrode and a bus electrode. The transparent electrode comprises an indium-tin oxide film (ITO film) and the like, and the bus electrode comprises Cr/Cu/Cr wiring, silver wiring, or the like. The display electrode 3 is arranged so as to intersect with the data electrode 4 formed on the rear substrate. Above these electrodes, a dielectric layer 9b having a function to protect the electrodes and a memory function to form wall charges at the time of electric discharge is formed. On the dielectric layer 9b, a protective layer 10 that protects the electrodes and the like from plasma is formed. As the protective layer 10, an MgO film is generally formed. Furthermore, on the front substrate side seen from the barrier rib, a black compound layer 13 (black matrix) having an opening corresponding to each pixel is formed. The appearance of black color from the front substrate side is effective in improving the contrast of an image.

The rear substrate and the front substrate are precisely aligned opposite to each other and the edge portions thereof are adhered to each other to form a adhering portion 12 A glass adhesive is used as the adhesive, and the internal gas is evacuated while heating and then a rare gas is filled into the interior. By applying a voltage to an area where a data electrode intersects with a display electrode, a rare gas is discharged and excited into a plasma state. Using an ultraviolet rays 11 generated when the rare gas returns from the plasma state to the original state, a phosphor emits light.

A plasma display is prepared in this manner. However, in a heating process after forming the black matrix, the black layer serving as a black matrix causes a problem such as that the blackness decreases due to heating under oxidization conditions or that the BM peels off from a contacting member. These problems were resolved in Examples shown below.

### EXAMPLE 1

In this example, the composition range of a vanadium phosphate based glass was studied first. A method for preparing the glass is shown below.

The starting materials are V₂O₅ (produced by Kojundo Chemical Laboratory, 99.9% purity), BaCO₃ (produced by Kojundo Chemical Laboratory, 99.9% purity), P₂O₅ (produced by Kojundo Chemical Laboratory, 99.9% purity), Sb₂O₃ (produced by Wako Pure Chemical Industries, Ltd, 99.9% purity), TeO₂ (produced by Kojundo Chemical Laboratory, 99.9% purity), Na₂CO₃ (produced by Kojundo Chemical Laboratory, 99.9% purity), and K₂CO₃ (produced by Kojundo Chemical Laboratory, 99.9% purity).

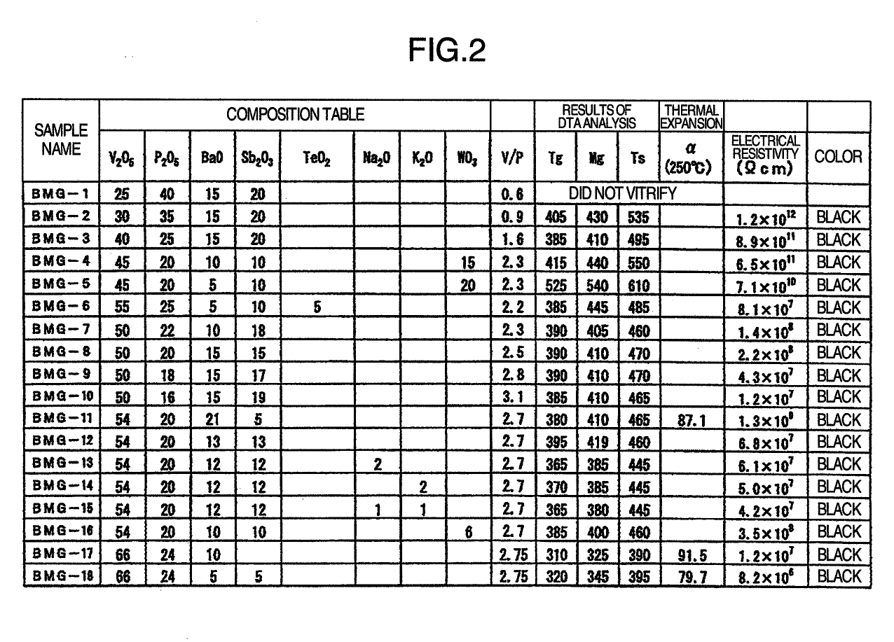

In order to prepare a glass used for the barrier rib, the respective materials were mixed with the weight ratio shown in FIG. 2, first. In addition, for BaCO₃, BaO equivalent was mixed since BaCO₃ can be decomposed into BaO and CO₂.

A platinum crucible containing the above-described powder mixture of raw materials was set in a glass furnace to start heating. Heating rate at this time was set to 5° C./min, and the platinum crucible is kept for one hour after reaching a target temperature. In this example, the target temperature was fixed to 1000° C. The melted glass was kept while stirring for one hour, and the platinum crucible was removed from a fusion furnace after keeping, and was cast into a graphite mold that was heated to 300° C. in advance.

The glass cast into the graphite mold was moved to a stress relieve furnace that was heated to a stress relieve temperature in advance, and the stress was removed by keeping for an hour, followed by cooling down to the room temperature at cooling rate of 1° C./min.

The obtained glass was 30 mm×40 mm×80 mm in size. The obtained glass block was ground, and a DTA analysis was carried out to evaluate the glass transition point (Tg) and the glass softening point.

BGM-1 glass sometimes did not vitrify. For the glass powders except this one, the following tests were conducted using a powder mixture into which 60 vol % of Al₂O₃ powder having an average particle diameter of 1 μm is mixed.

First, the powder mixture was formed into a cylindrical powder compact of 10 mm in diameter and 5 mm in height, and was calcined at a temperature of the softening temperature of each glass plus 100° C. for one hour in the atmosphere. The upper and lower sides of the sample after calcination were polished, and an Ag paste was applied thereto to form an electrode. The electric resistivity of the sample, on both sides of which an electrode was formed, was measured using a constant current applying method.

Since the result of electric resistivity evaluation revealed that the electric resistivity of any one of the samples has a high resistance exceeding 10⁷ Ωcm, each sample was formed as a barrier rib on a 5 inch glass substrate, and was subjected to a spark test.

The test samples were prepared as follows.

After forming a scan electrode on the 5 inch glass substrate, a dielectric paste was applied thereto and was calcined, and an MgO layer is further formed on top of this to prepare a front glass substrate.

Next, a data electrode is formed on the 5 inch glass substrate, and a dielectric paste was applied thereto and was calcined, and a protective film is further formed on top of this to form a rear glass substrate.

A paste-like material obtained by mixing a solvent and a dispersing agent into a powder mixture of glass and ceramics was printed as a barrier rib material onto the rear substrate and was calcined at a temperature of the softening temperatures of each glass plus 100° C. (i.e., in the range from 490° C. to 590° C.) for one hour in the atmosphere. The barrier rib layer after calcination is processed into a striped shape by a sandblasting method to form a barrier rib. Next, a phosphor is applied to the wall surface of the barrier rib. The baking temperature of the phosphor was set to 450° C.

For the assembly of the test panel, first, a sealing glass paste is applied to the peripheral portions of the front substrate and the rear substrate, and then the both substrates are bonded together and airtight sealed so that the opposing scan electrode and data electrode may intersect with each other. The sealing temperature of the panel was set to 450° C. Since 60 vol % of ceramic filler is mixed in the barrier rib, the barrier rib maintains its shape without losing the shape even at 450° C.

Next, evacuation is carried out through a P pipe provided in the peripheral portion of the panel, and then a rare gas used for a discharge gas is introduced and the P pipe is sealed. Here, the discharge gas contains Xe (xenon), and the composition ratio of Xe was set to 10%, and the “pd product”, which is a product of a discharge gas pressure p (Torr) and a distance between the discharge electrodes d (mm) was set to 200.

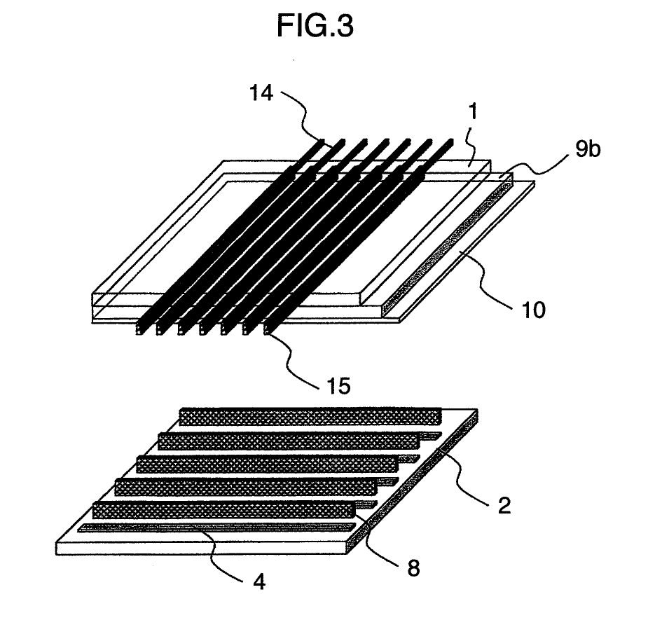

FIG. 1 shows the configuration diagram of the panel of the present invention. The front panel side comprises the front substrate 1, the display electrode 3, the dielectric layer 9, a protective film 10, and the like. As the display electrode 3, as shown in FIG. 3, a transparent electrode 14, a bus electrode 15, and the like are disposed in the direction intersecting with the barrier rib. On the rear panel side, the dielectric layer 9 and the barrier rib 8 are formed on the rear substrate 2, and further on top of these, the black compound layer 13 serving as a BM is formed.

In this case, for the black compound, the one in two layer state, in which a barrier rib material is printed and on top of this a black compound layer is also printed, is processed into a striped shape by a sandblasting method to form a barrier rib. As the black compound layer 13, those preventing degradation of the black color during production and having the softening temperature lower than that of the barrier rib material are selected, for example, BMG-14 to BMG-16 are used in the present invention. In this example, because the black compound has an excellent blackness, an excellent contrast is obtained, and at the same time the black compound will not peel off from the barrier rib material, which the black compound is in contact with, or from the MgO layer, which is a protective film, and further the number of process steps is similar to the conventional one.

### EXAMPLE 2

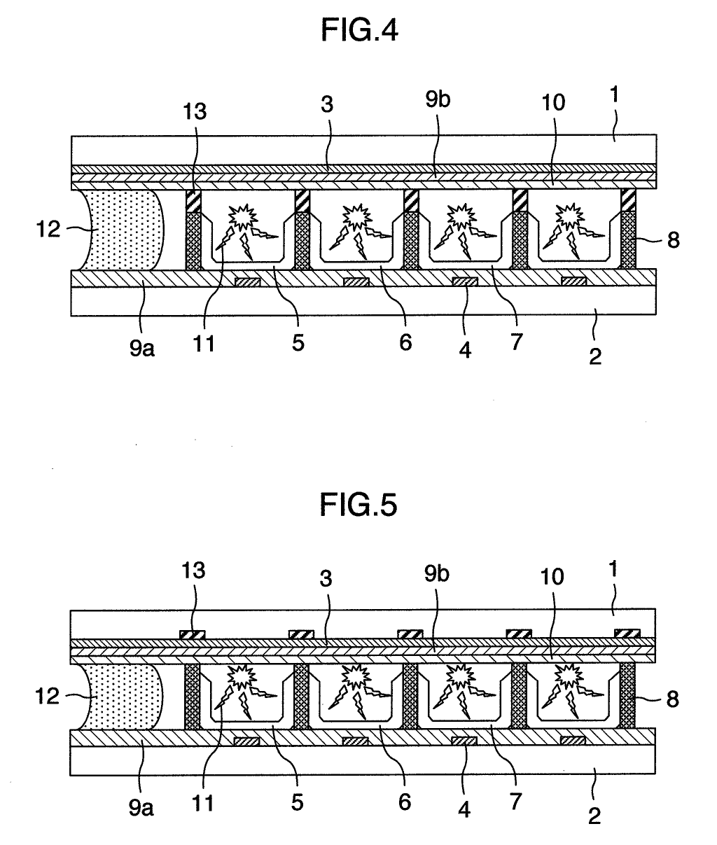

FIG. 4 shows an example in which the aspect ratio of the black compound layer 13 is increased. Here, this example can improve the contrast by reducing reflection of an incident light from the outside as well as emit a part of light from a phosphor toward the panel front by total reflection, so that further improvement in efficiency can be also achieved.

### EXAMPLE 3

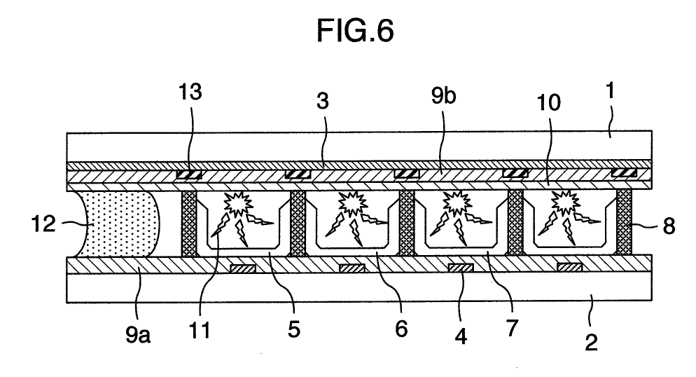

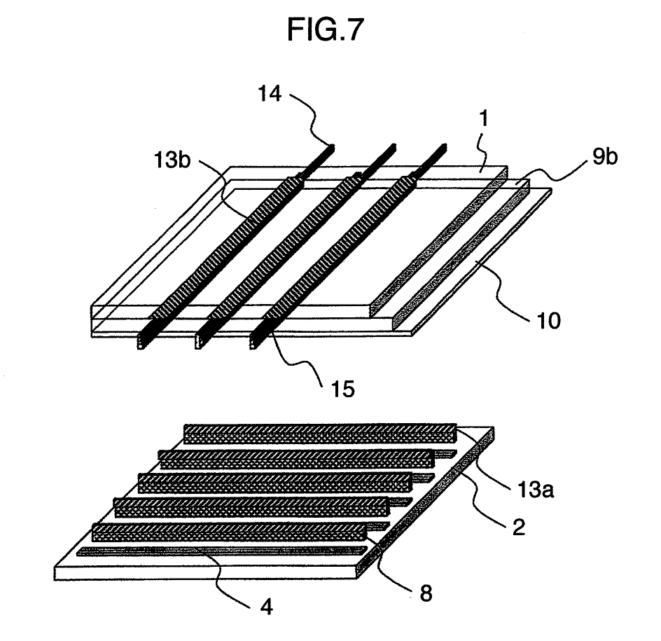

FIG. 5 shows an example in which the black compound layer 13 of the present invention is formed in contact with the front substrate 1 on the front panel side seen from the barrier rib 8. Moreover, as shown in FIG. 6, the display electrode 3 is formed on the front substrate 1, and in a portion, where a surface electrode is wired, the black compound layer 13 may be formed thereon and the protective layer 10 may be formed so as to cover this. At this time, the black compound layer 13 is prepared using, for example, BMG-2 to BMG-13 and the like. Furthermore, as shown in FIG. 7, the BM may be formed substantially in a matrix form by forming a black compound layer 13a on the barrier rib 8 and further forming a layer of a black compound 13b in a direction intersecting with the barrier rib 8.

Since the black compound layer 13b provided on the front substrate side has resistivity equal to or higher than 10⁷ Ωcm, charges stored in a dielectric substance will hardly leak through a barrier rib. However, preferably, black compounds of BGM-2 to BGM-4 had better be used.

### EXAMPLE 4

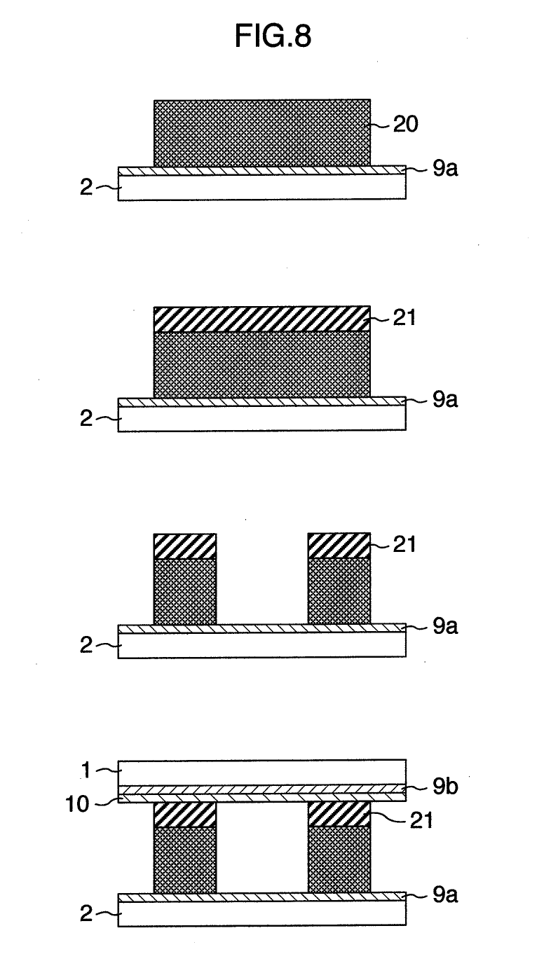

FIG. 8 shows a method of forming a black compound of the present invention. First, the dielectric layer 9a is formed on the rear substrate 2, and on top of this a barrier rib material 20 is thick-film printed. A black compound 21 is printed thereon. Here, if a photo-curing type paste is used as the black compound 21, this paste is irradiated with UV for curing when printing this. In the case of a heat-curing type paste, a two-layer state comprising a barrier rib material and a black compound is formed by heating after printing, first, and then is heat-cured. Subsequently, the resultant two layer structure is masked using a photolithography process or the like, and then by etching or sandblasting, the resultant two layer structure is removed except for a line-shaped or grid-shaped barrier rib and the black compound placed thereabove. The rear substrate prepared in this manner is integrated with the front substrate 1, in which the dielectric layer 9b, the protective layer 10, and the like are provided, by pressurizing and heating. As the black compound layer, BMG-14 to BMG-16 are suitable. Also in this case, because the black compound has an excellent blackness, an excellent contrast can be obtained and a peeling problem will not occur either.

### EXAMPLE 5

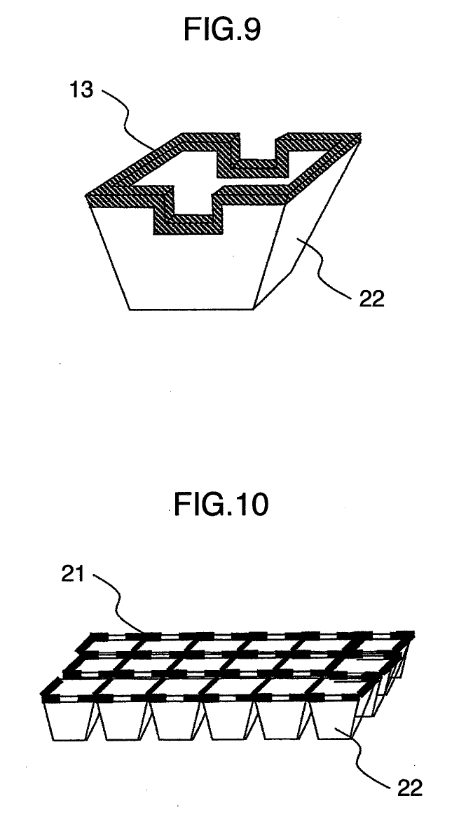

FIG. 9 shows an example in which for the purpose of evacuation a step is formed in a grid-shaped barrier rib. As the specific production method, in this example, after forming a grid-shaped barrier rib 22 by etching or sandblasting, a part thereof is processed to form the black compound layer 13 on the barrier rib. Moreover, as shown in FIG. 10, above the grid-shaped barrier rib 22, a black compound layer 21 may be printed in several tens of micrometers to several hundreds of micrometers thickness in a chain shape, and then the rear substrate may be integrated with a front substrate to form a barrier rib having an evacuation hole.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGE OF THE INVENTION

According to the present invention, regardless of heating in an oxidizing atmosphere, the blackness of a black compound serving as a BM can be kept, and a peeling problem of the BM will not occur and the number of process steps will not be increased.

1. A plasma display panel comprising:
a front substrate and a rear substrate, edge portions of which are adhered to each other, the both substrates being provided opposite to each other;
an electrode provided on the front substrate;
a dielectric layer provided on the electrode;
a protective layer provided on the dielectric layer;
a black compound layer having an opening on the protective layer;
an electrode provided on the rear substrate;
a dielectric layer provided on top of the electrode provided on the rear substrate;
a barrier rib holding a gap between the front substrate and the rear substrate; and
a phosphor filled in a space formed by the barrier rib,
wherein the plasma display panel comprises the black compound layer on a front substrate side seen from the barrier rib,
wherein the black compound layer comprises a mixture of a ceramics filler and a glass, and wherein the glass comprises a phosphate glass containing a transition metal element.

2. The plasma display panel according to claim 1, wherein the transition metal element comprises at least one kind selected from the group consisting of vanadium, tungsten, molybdenum, niobium, and iron.

3. The plasma display panel according to claim 1, wherein the glass has a composition ratio of 30 to 60 wt % of V₂O₅, 15 to 40 wt % of P₂O₅, 2 to 25 wt % of BaO, 5 to 30 wt % of Sb₂O₃, and 0 to 15 wt % of WO₃, in terms of oxides of each element.

4. The plasma display panel according to claim 1, wherein the glass contains sodium or potassium, and wherein a content of these alkali metals is equal to or less than 10 wt % in terms of R₂O oxides when the alkali metal is denoted by R.

5. The plasma display panel according to claim 1, wherein the glass contains TeO₂ and a content of the TeO₂ is equal to or less than 5 wt %.

6. The plasma display panel according to claim 1, wherein the glass has a composition ratio of 30 to 60 wt % of V₂O₅, 15 to 40 wt % of P₂O₅, 2 to 25 wt % of BaO, 5 to 30 wt % of Sb₂O₃, and 0 to 15 wt % of WO₃, in terms of oxides of each element, and wherein a ratio between the glass and the ceramic filler is 10 to 70 vol % of the glass with respect to 30 to 90 vol % of the ceramic filler.

7. The plasma display panel according to claim 6, wherein an average particle diameter of the ceramic filler is in the range from 1 μm to 10 μm.

8. The plasma display panel according to claim 7, wherein the ceramic filler is an oxide or composite oxide of one or more kinds selected from the group consisting of Fe, Mn, Co, Cu, Cr, Ru, Ti, Ni, Mo and Nd.

9. The plasma display panel according to claim 7, wherein the ceramic filler is one kind or a mixture of two or more kinds selected from the group consisting of SiO₂, ZrO₂, Al₂O₃, ZrSiO₄, cordierite, mullite, and eucryptite.

10. The plasma display panel according to claim 1, wherein the black compound layer is of a high aspect structure.

11. The plasma display panel according to claim 1, wherein the black compound layer is formed between the front substrate and the dielectric layer on the front substrate.

12. The plasma display panel according to claim 1, wherein the black compound layer is arranged on an upper part of the barrier rib and is also arranged in a direction intersecting with the barrier rib on the front substrate.

13. The plasma display panel according to claim 1, wherein a step exists in a part of the barrier rib, or the black compound layer is formed in a chain shape on the barrier rib.

14. The plasma display panel according to claim 3, wherein a resistivity of the black compound is equal to or higher than 10⁷ Ωcm.

15. A method for manufacturing a plasma display panel comprising:
a front substrate and a rear substrate, edge portions of which are adhered to each other, the both substrates being provided opposite to each other;
an electrode provided on the front substrate;
a dielectric layer provided on the electrode;
a protective layer provided on the dielectric layer;
a black compound layer having an opening on the protective layer;
an electrode provided on the rear substrate;
a dielectric layer provided on top of the electrode on the rear substrate;
a barrier rib holding a gap between the front substrate and the rear substrate; and
a phosphor filled in a space formed by the barrier rib,
the method comprising:
printing a barrier rib material on the protective layer on the front substrate;
printing, on the barrier rib material printed, a black compound paste comprising a mixture of a ceramics filler and a glass;
subjecting to a curing treatment and then removing a part thereof; and thereafter
melting the black compound to integrate the rear substrate with the front substrate.

16. A method for manufacturing a plasma display panel comprising:
a front substrate and a rear substrate, edge portions of which are adhered to each other, the both substrates being provided opposite to each other;
an electrode provided on the front substrate;
a dielectric layer provided on the electrode;
a protective layer provided on the dielectric layer;
a black compound layer having an opening on the protective layer;
an electrode provided on the rear substrate;
a dielectric layer provided on top of the electrode on the rear substrate;
a barrier rib holding a gap between the front substrate and the rear substrate; and
a phosphor filled in a space formed by the barrier rib,
the method comprising:
printing a barrier rib material on the protective layer on the front substrate;
printing, on the barrier rib material printed, a black compound paste comprising a mixture of a ceramics filler and a glass and subjecting to a heating to thereby form a black compound layer; and subsequently
joining the front substrate to the rear substrate to form a panel.
